(19) United States
(12) Patent Application Publication
(10) Pub. No.: US 2024/0028649 A1
(43) Pub. Date: Jan. 25, 2024

(54) INFORMATION PROVISION SYSTEM AND STORAGE MEDIUM

(71) Applicant: TOYOTA JIDOSHA KABUSHIKI KAISHA, Toyota-shi (JP)

(72) Inventors: Taizo MASUDA, Yokohama-shi (JP); Kiyoto SASAKI, Susono-shi (JP); Daisuke KAKUMA, Toyota-shi (JP); Hiroyoshi MASUI, Susono-shi (JP); Akihiro YAMAGUCHI, Toyota-shi (JP); Sokfan YEE, Toyota-shi (JP); Yuki NISHIKAWA, Numazu-shi (JP)

(73) Assignee: TOYOTA JIDOSHA KABUSHIKI KAISHA, Toyota-shi (JP)

(21) Appl. No.: 18/137,679

(22) Filed: Apr. 21, 2023

(30) Foreign Application Priority Data
Jul. 22, 2022 (JP) 2022-117304

(51) Int. Cl. G06F 16/907; G06T 7/90

(52) U.S. Cl. CPC G06F 16/907; G06T 7/90; G06T 2207/10024

(57) ABSTRACT

An information provision system proposes an action item including at least one of a destination and a vehicle to a user. A database indicates a correspondence between a category of clothing and the action item that is recommended. The information provision system acquires an image showing user's clothing that is clothing of the user, and recognizes the category of the user's clothing based on the image. The information provision system further refers to the database to select the action item recommended for the category of the user's clothing as a recommended action item. The information provision system then proposes the recommended action item to the user.

### CROSS-REFERENCE TO RELATED APPLICATION

This application claims priority to Japanese Patent Application No. 2022-117304 filed on Jul. 22, 2022 incorporated herein by reference in its entirety.

### BACKGROUND

### 1. Technical Field

The present disclosure relates to a technology for proposing at least one of a destination and a vehicle to a user.

### 2. Description of Related Art

Japanese Unexamined Patent Application Publication No. 2020-134953 (JP 2020-134953 A) discloses an information processing device that provides information to a user. The information processing device stores a user attribute including user's needs, preferences, or characteristics. This user attribute is entered by the user himself/herself. The information processing device identifies a facility suitable for the user attribute. Furthermore, the information processing device provides the user with information on facilities that the user has not yet visited among the identified facilities.

### SUMMARY

There is room for improvement in the technology for providing information suitable for the user's preferences and the like. One object of the present disclosure is to provide a technology capable of proposing at least one of a destination and a vehicle suitable for the user to the user.

A first aspect relates to an information provision system for proposing an action item including at least one of a destination and a vehicle to a user. The information provision system includes: one or more processors; and one or more storage devices for storing a database showing a correspondence between a category of clothing and the action item that is recommended. The one or more processors are configured to acquire an image showing user's clothing that is clothing of the user, recognize a category of the user's clothing based on the image, refer to the database to select the action item recommended for the category of the user's clothing as a recommended action item, and propose the recommended action item to the user.

A second aspect relates to a storage medium storing an information provision program for proposing an action item including at least one of a destination and a vehicle to a user. A database indicates a correspondence between a category of clothing and the action item that is recommended. By being executed by a computer, the information provision program causes the computer to perform acquiring an image showing user's clothing that is clothing of the user, recognizing a category of the user's clothing based on the image, referring to the database to select the action item recommended for the category of the user's clothing as a recommended action item, and proposing the recommended action item to the user.

According to the present disclosure, a recommended action item (at least one of a destination and a vehicle) is selected and proposed to the user based on the category of the user's clothing. The category of the user's clothing reflects the preference and the mood of the user. Also, by considering the category of the user's clothing, it is possible to exclude action items that do not match the user's clothing. Therefore, it is possible to propose to the user a recommended action item suitable for the user.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram illustrating an outline of an information provision system according to an embodiment;

FIG. 2 is a diagram showing various examples of clothing categories in the embodiment;

FIG. 3 is a conceptual diagram illustrating an outline of an information provision process of the information provision system according to the embodiment;

FIG. 4 is a block diagram showing a configuration related to the information provision system according to the embodiment;

FIG. 5 is a block diagram showing a configuration of the information provision system according to the embodiment;

FIG. 6 is a flowchart showing the information provision process of the information provision system according to the embodiment;

FIG. 7 is a conceptual diagram showing an example of a vehicle-related database according to the embodiment;

FIG. 8 is a flowchart showing an example of step S300 in the vehicle-related information provision process according to the embodiment;

FIG. 9 is a conceptual diagram showing another example of a vehicle-related database according to the embodiment;

FIG. 10 is a conceptual diagram showing an example of a destination-related database according to the embodiment;

FIG. 11 is a conceptual diagram showing another example of the destination-related database according to the embodiment; and

FIG. 12 is a flowchart showing an example of step S300 in the destination-related information provision process according to the embodiment.

### DETAILED DESCRIPTION OF EMBODIMENTS

Embodiments of the present disclosure will be described with reference to the accompanying drawings.

### 1. Outline

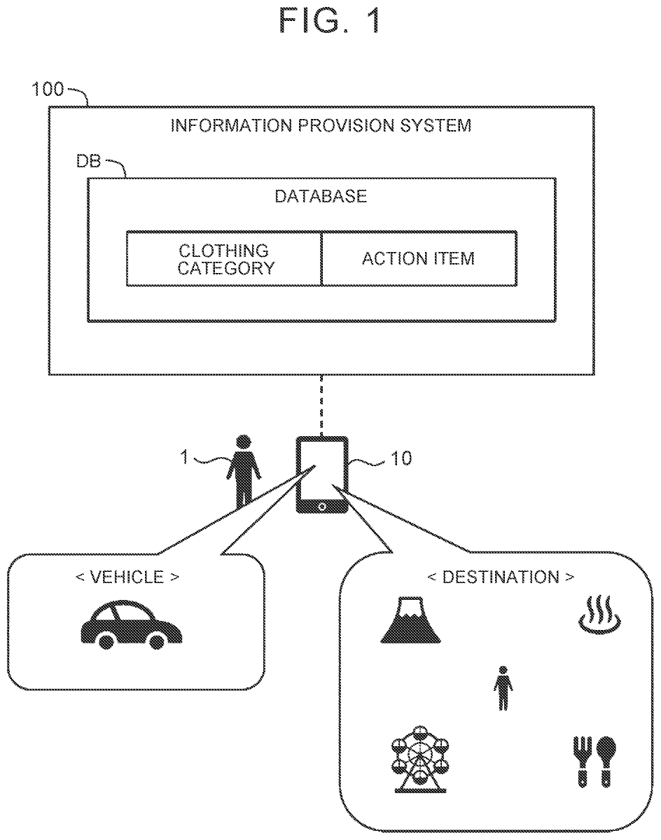

FIG. 1 is a conceptual diagram illustrating an outline of an information provision system 100 according to the present embodiment. The information provision system 100 provides a user 1 with various information. Typically, the information provision system 100 provides various information to the user 1 through the terminal 10 operated by the user 1. For example, the terminal 10 is the mobile terminal (e.g., smart phone) of the user 1. As another example, the terminal 10 may be an information terminal (e.g., digital signage) installed in towns or buildings.

The following considers providing useful information for “going out” such as sightseeing, driving, shopping, and dining. For example, the information provision system 100 proposes recommended destinations to the user 1. Examples of destinations include sightseeing spots, scenic spots, hiking trails, entertainment facilities, commercial facilities, restaurants, and the like. As another example, the information provision system 100 may propose a recommended vehicle (mobility) to the user 1. A vehicle may be used to move to a destination, or may be used to go for a drive.

In the following description, “action item ACT” is a concept that includes at least one of a destination and a vehicle. The action item ACT may include both a destination and a vehicle. The information provision system 100 proposes (recommends) an action item ACT to the user 1. In particular, the information provision system 100 automatically proposes (recommends) an action item ACT suitable for the user 1 in consideration of the preference, the mood, and the like of the user 1.

Regarding the proposal of the action item ACT, the inventors of the present application focused on the “clothing” of the user 1. The clothing of the user 1 is considered to reflect the preference and the mood of the day of the user 1. Therefore, by considering the clothing of the user 1, it is possible to grasp the preference and the mood of the user 1. Also, by considering the clothing of the user 1, it is possible to exclude the action item ACT that does not match the clothing of the user 1 from the options.

Therefore, the information provision system 100 according to the present embodiment automatically proposes (recommends) an action item ACT suitable for the user 1 in consideration of the clothing of the user 1. For this purpose, a database DB is prepared in advance that indicates the correspondence between the clothing category and the recommended action item ACT. The clothing category is the category of the clothing of the user 1.

FIG. 2 shows various examples of the clothing categories. In FIG. 2, the clothing categories are defined in terms of three aspects: atmosphere, color tone, and functionality. Examples of the “atmosphere of clothing”, which is one aspect of the clothing category, include “sporty” and “dressy”, which contradict each other. Examples of the “color tone of clothing”, which is another aspect of the clothing category, include “colorful” and “monochrome”, which contradict each other. Examples of the “functionality of clothing”, which is still another aspect of the clothing category, include “easy to move” and “difficult to move”, which contradict each other.

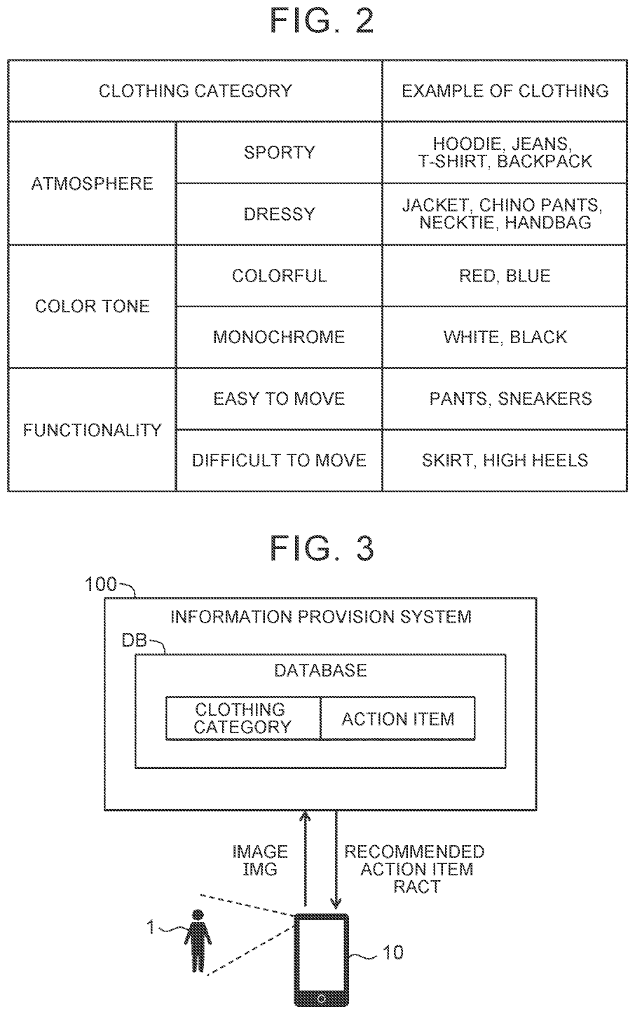

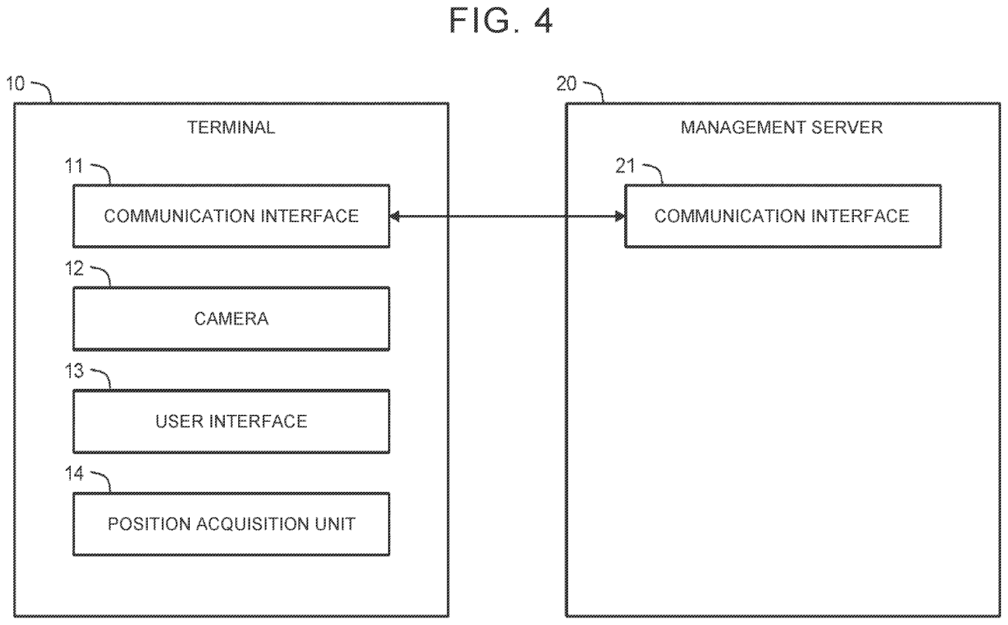

FIG. 3 is a conceptual diagram illustrating an outline of an information provision process of the information provision system 100. The terminal 10 is equipped with a camera that captures an image of the user 1. An image IMG captured by the camera of the terminal 10 shows the user's clothing, which is the clothing of the user 1. The information provision system 100 acquires the image IMG showing the user's clothing, and recognizes the category of the user's clothing based on the image IMG. Image recognition artificial intelligence (AI) obtained through machine learning, for example, is used to recognize the category of the user's clothing based on the image IMG.

The information provision system 100 holds the database DB that indicates the correspondence between the clothing category and the recommended action item ACT. The information provision system 100 refers to the database DB and selects the action item ACT recommended for the category of the user's clothing. The action item ACT selected here, that is, the action item ACT associated with the category of the user's clothing is hereinafter referred to as “recommended action item RACT”. The recommended action item RACT includes at least one of a recommended destination and a recommended vehicle.

The information provision system 100 proposes the recommended action item RACT to the user 1. That is, the information provision system 100 notifies the terminal 10 of proposal information indicating the recommended action item RACT, and the terminal 10 presents the proposal information to the user 1. For example, the terminal 10 displays the proposal information indicating the recommended action item RACT on a display device.

### Effects

As described above, according to the present embodiment, a recommended action item RACT is selected based on the category of the user's clothing and proposed to the user 1. The category of the user's clothing reflects the preference and the mood of the user 1. Also, by considering the category of the user's clothing, it is possible to exclude action items ACT that do not match the user's clothing. Therefore, it is possible to propose to the user 1 a recommended action item RACT suitable for the user 1.

In addition, according to the present embodiment, the user 1 does not need to input his/her preferences and moods in detail. The user 1 only needs to capture an image of himself/herself using the camera of the terminal 10. Then, the information provision system 100 automatically proposes a recommended action item RACT suitable for the user 1.

The clothing of the user 1 may reflect latent preferences of which the user 1 himself/herself is unaware. In that case, the information provision system 100 may propose a recommended action item RACT that the user 1 himself/herself would not have come up with. Therefore, the user 1 has more opportunities to make new discoveries.

A specific example of the information provision system 100 according to the present embodiment will be described below.

### 2. Example of Information Provision System

### 2-1. Configuration Example

FIG. 4 is a block diagram showing the terminal 10 and a management server 20 as components related to the information provision system 100. The terminal 10 is operated by the user 1. Examples of the terminal 10 include a mobile terminal (e.g., smart phone) of the user 1, an information terminal (e.g., digital signage) installed in towns and buildings, and the like. The terminal 10 and the management server 20 can communicate with each other.

The terminal 10 includes a communication interface 11, a camera 12, a user interface 13, and a position acquisition unit 14. The terminal 10 communicates with the management server 20 via the communication interface 11. The camera 12 captures images of the surroundings of the terminal 10. The user interface 13 is an interface for receiving information from the user 1 and providing information to the user 1. Examples of the user interface 13 include a touch panel, a keyboard, a display device, and the like. The position acquisition unit 14 acquires position information of the terminal 10 using a global navigation satellite system (GNSS).

The management server 20 includes a communication interface 21. The management server 20 communicates with the terminal 10 via the communication interface 21.

For example, the information provision system 100 is included in the terminal 10. As another example, the information provision system 100 may be included in the management server 20. When the information provision system 100 is included in the management server 20, the information provision system 100 communicates with the terminal 10 to acquire necessary information from the terminal 10 and provide various information to the terminal 10. As yet another example, the information provision system 100 may be distributed between the terminal 10 and the management server 20. In general, the information provision system 100 has the following configuration.

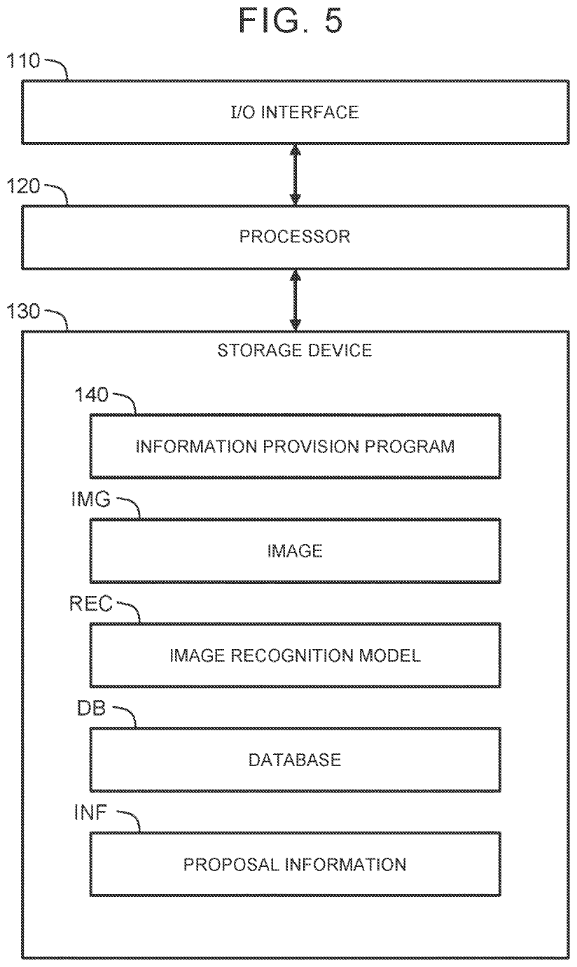

FIG. 5 is a block diagram showing the configuration of the information provision system 100. The information provision system 100 includes an input/output (I/O) interface 110, one or more processors 120 (hereinafter simply referred to as “processor 120”), and one or more storage devices 130 (hereinafter simply referred to as “storage device 130”).

The I/O interface 110 is an interface for receiving various information and outputting various information. For example, when the information provision system 100 is included in the terminal 10, the I/O interface 110 includes the communication interface 11 and the user interface 13. As another example, when the information provision system 100 is included in the management server 20, the I/O interface 110 includes the communication interface 21.

The processor 120 performs various information processes. For example, the processor 120 includes a central processing unit (CPU). Various information necessary for processing by the processor 120 is stored in the storage device 130. Examples of the storage device 130 include a volatile memory, a non-volatile memory, a hard disk drive (HDD), a solid state drive (SSD), and the like.

An information provision program 140 is a computer program executed by the processor 120. The functions of the information provision system 100 are realized through cooperation between the processor 120 executing the information provision program 140 and the storage device 130. The information provision program 140 is stored in the storage device 130. The information provision program 140 may be recorded on a computer-readable recording medium (storage medium). The information provision program 140 may be provided via a network. The information provision program 140 may be an application executed by the terminal 10 (e.g., smart phone).

Furthermore, the storage device 130 stores an image IMG, an image recognition model REC, a database DB, proposal information INF, and the like.

The image IMG is captured by the camera 12 of the terminal 10. The user's clothing that is the clothing of the user 1 is shown in the image IMG.

The image recognition model REC is an AI model capable of recognizing (classifying) the category of the user's clothing shown in the image IMG. The category of the clothing may include three aspects: atmosphere, color tone, and functionality (see FIG. 2). The image recognition model REC is generated in advance through machine learning such as deep learning and provided to the information provision system 100.

The database DB indicates the correspondence between the clothing category and the recommended action item ACT. An example of the database DB is as explained in FIG. 2 above. The database DB is created in advance by a system designer and provided to the information provision system 100.

The proposal information INF is information including a recommended action item RACT that is proposed to the user 1.

### 2-2. Processing Flow

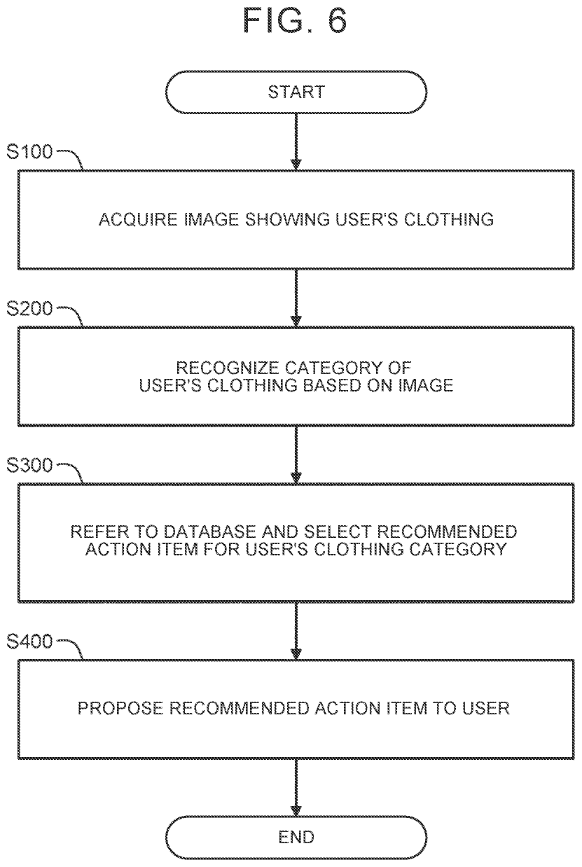

FIG. 6 is a flowchart showing the information provision process of the processor 120 of the information provision system 100.

In step S100, the processor 120 acquires an image IMG showing the user's clothing. More specifically, the user 1 operates the user interface 13 of the terminal 10 to activate the camera 12. The camera 12 captures an image of the user 1 and acquires an image IMG showing the user's clothing. When the processor 120 is included in the terminal 10, the processor 120 acquires the image IMG from the camera 12. As another example, when the processor 120 is included in the management server 20, the processor 120 communicates with the terminal 10 via the I/O interface 110 (the communication interface 21) and acquires the image IMG from the terminal 10.

In step S200, the processor 120 recognizes the category of the user's clothing based on the image IMG. More specifically, the processor 120 recognizes the category of the user's clothing shown in the image IMG by inputting the image IMG into the image recognition model REC. The category of the user's clothing may include three aspects: atmosphere, color tone, and functionality (see FIG. 2).

In step S300, the processor 120 refers to the database DB and selects an action item ACT recommended for the category of the user's clothing as a recommended action item RACT.

In step S400, the processor 120 proposes to the user 1 the recommended action item RACT. More specifically, the processor 120 presents the proposal information INF including the recommended action item RACT to the user 1 via the I/O interface 110. For example, when the processor 120 is included in the terminal 10, the processor 120 presents the proposal information INF to the user 1 via the user interface 13 (e.g., display device). As another example, when the processor 120 is included in the management server 20, the processor 120 transmits the proposal information INF to the terminal 10 via the communication interface 21 and instructs the terminal 10 to present the proposal information INF to the user 1.

### 3. Proposal of Vehicle

Section 3 describes the case where the action item ACT includes a vehicle. In this case, a vehicle-related database DB is used. The vehicle-related database DB includes a first database DB-1 that indicates the correspondence between clothing categories and recommended vehicles.

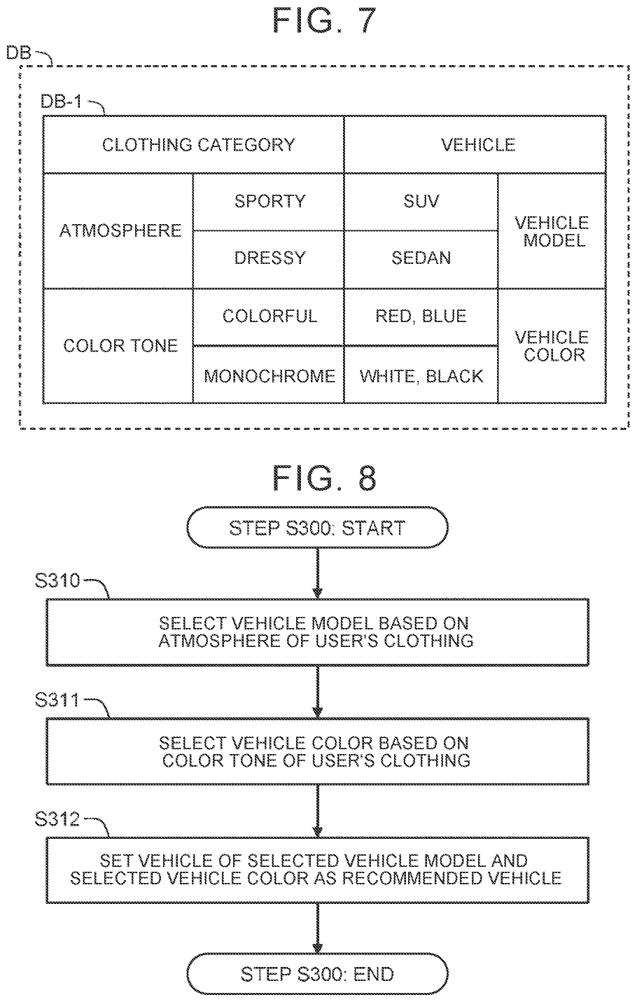

FIG. 7 is a conceptual diagram showing an example of the first database DB-1. In the example shown in FIG. 7, a vehicle is defined by the vehicle model and the vehicle color. Examples of vehicle models include sedans, SUVs, wagons, minivans, and the like. As the clothing category, the above-mentioned “atmosphere of clothing” and “color tone of clothing” are used (see FIG. 2). As shown in FIG. 7, “atmosphere of clothing” and “recommended vehicle model” are associated with each other, and “color tone of clothing” and “recommended vehicle color” are associated with each other. That is, the first database DB-1 indicates the correspondence between “atmosphere of clothing” and “recommended vehicle model”, and the correspondence between “color tone of clothing” and “recommended vehicle color”.

FIG. 8 is a flowchart showing an example of step S300 in the vehicle-related information provision process.

In step S310, the processor 120 refers to the first database DB-1 and selects a vehicle model recommended for the atmosphere of the user's clothing.

In step S311, the processor 120 refers to the first database DB-1 and selects a vehicle color recommended for the color tone of the user's clothing.

In step S312, the processor 120 sets the vehicle of the selected vehicle model and the selected vehicle color (e.g., a red SUV) as a recommended vehicle. This recommended vehicle is the recommended action item RACT proposed to the user 1.

As a modification, only one of step S310 and step S311 may be performed. That is, only one of the vehicle model and the vehicle color may be selected according to the user's clothing. When only the vehicle model is selected, the vehicle of the selected vehicle model is set as the recommended vehicle. On the other hand, when only the vehicle color is selected, the vehicle with the selected vehicle color is set as the recommended vehicle.

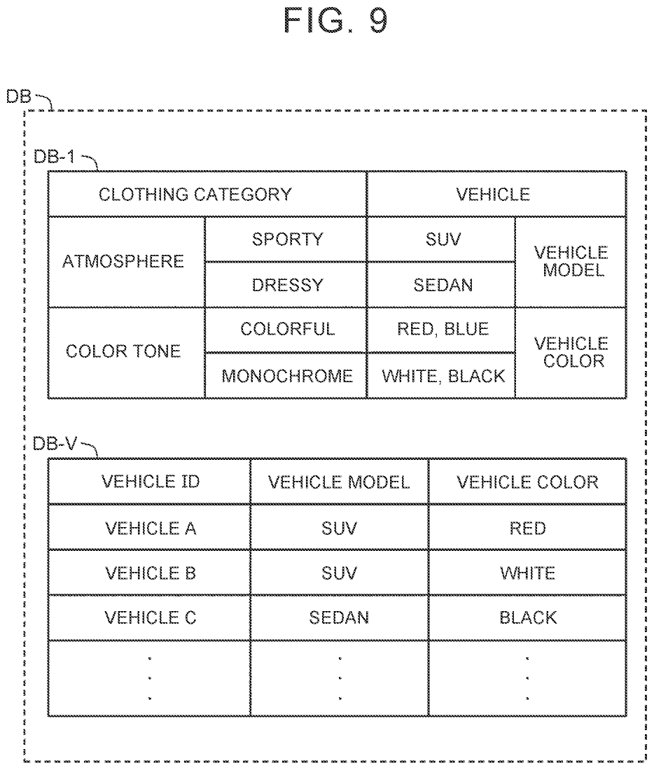

FIG. 9 is a conceptual diagram showing another example of the vehicle-related database DB. In the example shown in FIG. 9, the vehicle-related database DB includes a vehicle database DB-V in addition to the first database DB-1. The vehicle database DB-V indicates the correspondence among specific vehicle IDs, vehicle models, and vehicle colors. By also referring to the vehicle database DB-V, the processor 120 can propose to the user 1 a specific vehicle corresponding to the recommended vehicle set in step S312.

For example, the position acquisition unit 14 (see FIG. 4) of the terminal 10 acquires the position of the terminal 10 as the current position of the user 1. Alternatively, the user 1 uses the user interface 13 to specify a desired position. The processor 120 acquires the current position of the user 1 or the position designated by the user 1 as a reference position. In addition, the processor 120 acquires the vehicle database DB-V for currently available vehicles from a management system that manages available rental car services or car sharing services around the reference position. By referring to the above vehicle database DB-V, the processor 120 can propose to the user 1 a specific vehicle corresponding to the recommended vehicle set in step S312.

### 4. Proposal of Destination

Section 4 describes the case where the action item ACT includes a destination. In this case, a destination-related database DB is used. The destination-related database DB includes a second database DB-2 that indicates the correspondence between clothing categories and recommended destinations.

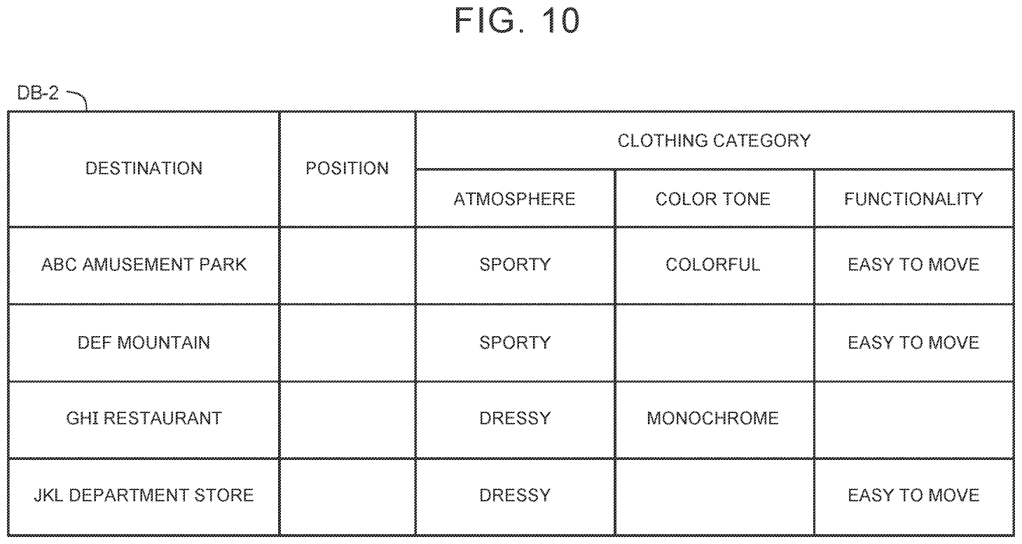

FIG. 10 is a conceptual diagram showing an example of the second database DB-2. In the example shown in FIG. 10, the second database DB-2 indicates the correspondence between the destination, the position of the destination, and the clothing category suitable for the destination. The clothing category includes three aspects: atmosphere, color tone, and functionality. For example, sporty, colorful, and easy-to-move-in clothing is suitable for “ABC Amusement Park”. Conversely, the recommended destination for sporty, colorful, and easy-to-move-in clothing is “ABC Amusement Park”.

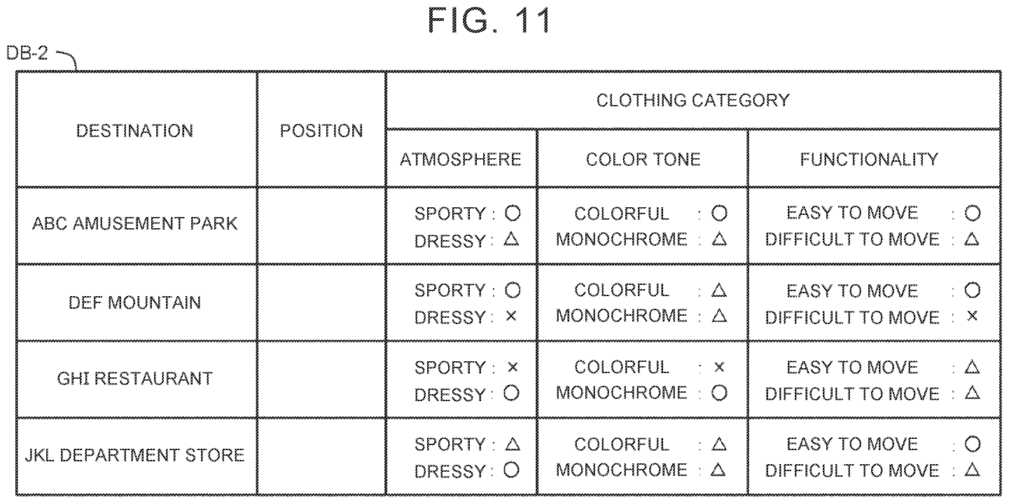

FIG. 11 is a conceptual diagram showing another example of the second database DB-2. In the example shown in FIG. 11, the second database DB-2 shows the correspondence between the destination, the position of the destination, and the suitability of the destination for the clothing category. The suitability of the destination for the clothing category is defined for each specific item of the clothing category. In FIG. 11, ◯ means high suitability, Δ means not low suitability, and × means low suitability.

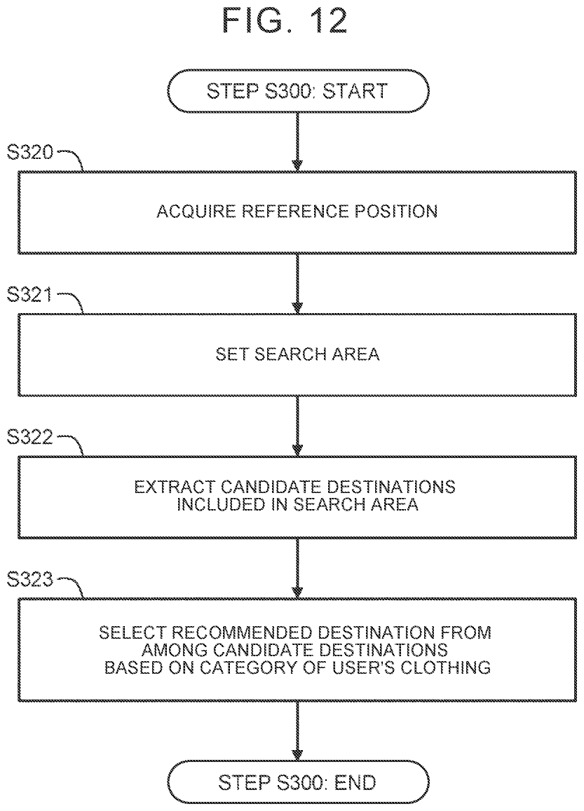

FIG. 12 is a flowchart showing an example of step S300 in the destination-related information provision process.

In step S320, the processor 120 acquires information of the current position of the user 1 or the position designated by the user 1. For example, the position acquisition unit 14 (see FIG. 4) of the terminal 10 acquires the position of the terminal 10 as the current position of the user 1. Alternatively, the user 1 uses the user interface 13 to specify a desired position. The processor 120 acquires the current position of the user 1 or the position designated by the user 1 as the reference position.

In step S321, the processor 120 sets a search area including the reference position. For example, the search area is an area within a first distance from the reference position. The first distance may be a fixed distance or may be designated by the user 1. As another example, the search area is an area reachable within a first time from the reference position. The first time may be a fixed time or may be designated by the user 1. When the user 1 makes a designation, the user interface 13 is used.

In step S322, the processor 120 extracts candidate destinations included in the search area. As described above, the second database DB-2 includes the position information for each destination. The processor 120 extracts one or more destinations included in the search area from all destinations registered in the second database DB-2, as candidate destinations.

In step S323, the processor 120 selects a recommended destination from among the candidate destinations. More specifically, the processor 120 refers to the second database DB-2 and selects a candidate destination recommended for the category of the user's clothing as the recommended destination.

For example, in the case of the second database DB-2 shown in FIG. 10, the processor 120 acquires, for each candidate destination, information of the clothing category suitable for the candidate destination. The processor 120 then selects the candidate destination that has the most items matching the category of the user's clothing as the recommended destination.

As another example, in the case of the second database DB-2 shown in FIG. 11, the processor 120 calculates a score for each candidate destination based on the category of the user's clothing. For example, when the suitability for the category of the user's clothing is ◯, the score is added. When the suitability for the category of the user's clothing is ×, the score is deducted. When the suitability for the category of the user's clothing is Δ, the score is not added nor deducted. The processor 120 then selects the candidate destination with the highest score as the recommended destination.

Thus, the processor 120 selects the recommended destination from among the candidate destinations based on the category of the user's clothing. The recommended destination is the recommended action item RACT proposed to the user 1.

### 5. Combination

Sections 3 and 4 described above can also be combined. That is, the processor 120 may propose both the recommended vehicle and the recommended destination to the user 1.

What is claimed is:

1. An information provision system for proposing an action item including at least one of a destination and a vehicle to a user, the information provision system comprising:
one or more processors; and
one or more storage devices for storing a database showing a correspondence between a category of clothing and the action item that is recommended, wherein the one or more processors are configured to
acquire an image showing user's clothing that is clothing of the user,
recognize a category of the user's clothing based on the image,
refer to the database to select the action item recommended for the category of the user's clothing as a recommended action item, and
propose the recommended action item to the user.

2. The information provision system according to claim 1, wherein:
the action item includes the vehicle;
the category of the clothing includes a color tone of the clothing;
the database indicates a correspondence between the color tone of the clothing and a recommended vehicle color of the vehicle; and
the one or more processors are configured to
refer to the database to select the vehicle color recommended for the color tone of the user's clothing,
set the vehicle of the selected vehicle color as a recommended vehicle, and
propose the recommended vehicle to the user.

3. The information provision system according to claim 1, wherein:
the action item includes the vehicle;
the category of the clothing includes an atmosphere of the clothing;
the database indicates a correspondence between the atmosphere of the clothing and a recommended vehicle model of the vehicle; and
the one or more processors are configured to
refer to the database to select the vehicle model recommended for the atmosphere of the user's clothing,
set the vehicle of the selected vehicle model as a recommended vehicle, and
propose the recommended vehicle to the user.

4. The information provision system according to claim 1, wherein:
the action item includes the destination;
the database indicates a correspondence between the category of the clothing and the destination that is recommended; and
the one or more processors are configured to
refer to the database to select the destination recommended for the category of the user's clothing as a recommended destination, and
propose the recommended destination to the user.

5. The information provision system according to claim 4, wherein the one or more processors are further configured to
acquire a current position of the user or a position designated by the user as a reference position,
set a search area including the reference position, and
select the recommended destination from among candidate destinations included in the search area.

6. A non-transitory storage medium storing an information provision program that is executed by a computer and that proposes an action item including at least one of a destination and a vehicle to a user, wherein:
a database indicates a correspondence between a category of clothing and the action item that is recommended; and
the information provision program causes the computer to execute
acquiring an image showing user's clothing that is clothing of the user,
recognizing a category of the user's clothing based on the image,
referring to the database to select the action item recommended for the category of the user's clothing as a recommended action item, and
proposing the recommended action item to the user.
